(19) United States
(12) Patent Application Publication
(10) Pub. No.: US 2026/0337365 A1
(43) Pub. Date: Oct. 29, 2026

(54) MECHANOCHEMICAL CATALYTIC DEPOLYMERISATION

(71) Applicant: Universiteit Utrecht Holding B.V., Utrecht (NL)

(72) Inventors: Ina VOLLMER, Utrecht (NL); Bert Marc WECKHUYSEN, Houten (NL); Adrian Henrik HERGESELL, Utrecht (NL)

(21) Appl. No.: 19/122,176

(22) PCT Filed: Oct. 17, 2023
(86) PCT No.: PCT/NL2023/050544

§ 371 Date: Apr. 17, 2025

(30) Foreign Application Priority Data
Oct. 17, 2022 (EP) 22201902.8

(51) Int. Cl. C08J 11/16; B01J 23/30; B01J 27/053; B01J 35/51; B01J 37/06

(52) U.S. Cl. CPC C08J 11/16; B01J 23/30; B01J 27/053; B01J 35/51; B01J 37/06; C08J 2323/06; C08J 2323/12; C08J 2325/06

(57) ABSTRACT

The disclosure pertains to method of depolymerizing plastic material using certain grinding media, to the grinding media, and to methods of manufacturing the grinding media. The grinding media are catalytically functionalized. In an example embodiment, milling balls (1) can be used for the depolymerization of polymers (2), such as polyolefins. The zirconia milling balls are sulfated (3) to enhance solid acid catalytic functionality. The vigorous motion (4) during milling and the catalytic functionality synergistically contribute to depolymerisation.

### FIELD

The invention pertains to the processing of plastic waste materials, in particular to mechanochemical depolymerization, for instance for the value-added recycling of plastic waste.

### INTRODUCTION

A traditionally used approach to recycling plastic waste material is mechanical recycling. However, mechanical recycling of plastic waste materials is typically accompanied by degraded plastic properties. An example method of mechanical recycling is based on melting and re-extrusion of the plastic material.

EP3757084 relates to mechanochemical process for directly heterogeneously catalysing a chemical reaction comprising wherein a shaped body comprising at least one catalytically active material is brought in contact with a starting material for the direct mechanochemical conversion of the starting material to a product. The document does not teach, at least, surface modification of the shaped body, and Example 1 of said document is directed to polymerization.

JP2001031793 relates to a method for removing chlorine from vinyl chloride-coated electric wire covering waste material, which comprises inserting a magnetic metal ball of a suitable size, heating the inner tube, and removing chlorine from the vinyl chloride-coated electric wire covering waste material. The document does not teach, at least, surface modification of the metal ball.

US 2022/097110 mentions an embodiment catalytically active particles and/or the coatings are applied to grinding bodies, drive shafts, walls of the grinding chamber and/or to the agitation means and/or can be introduced into the grinding chamber of the mechanical mills. The document does not teach, at least, surface modification of the grinding bodies.

WO2022160371 mentions a degradation method for a polyester-type plastic, the method involving mixing polyester plastic fragments with a catalyst, and the catalyst is indicated as an acid catalyst, a base catalyst, a metal oxide catalyst, a metal salt catalyst, or a polyoxometalate catalyst. The document does not teach, at least, surface modification of grinding media.

WO 2021/168402/US20230107759A1 mentions a method for recycling synthetic polymers by combining the polymers with a solid depolymerizing catalyst, e.g. solid NaOH, in a vessel, mechanically shearing the combined polymers and catalyst against each other to produce monomers from the polymers; and collecting the monomers. The document does not teach, at least, surface modification of grinding media.

US 2007/173673 mentions a method for catalytically cracking waste plastics wherein waste plastics are loaded as a raw material into a granular FCC catalyst heated to a temperature range from 350 °C to 500 °C inside a reaction vessel. The document does not mention, at least, grinding media.

WO 2021/156616/US20230053932A1 mentions a method processing hydrocarbons for recycling, the method involving a step wherein hydrocarbon gas with a catalyst which includes or is prepared from a transition metal or transition metal salt, and a carbide, to reduce chain lengths of hydrocarbons in the hydrocarbon gas and produce hydrocarbon products. The apparatus for the process comprises in an embodiment a grinding system for mechanically breaking down solid hydrocarbons. The document does not teach, at least, surface modification of grinding media.

Without wishing to give a survey of the non-patent literature, two further references are identified.

Vollmer et al., Angew. Chemie Int. Ed. 2020, 59, 15402-15423, review various approaches to chemical recycling of plastic materials. Chemical recycling of plastic, i.e. polymeric, materials is generally directed to the conversion of plastic waste material into monomers and oligomers. One class of chemical recycling methods is based on (catalytic) pyrolysis. This, however, requires high temperatures (e.g. above 400 °C) for polyolefins such as polypropylene (PP) and polyethylene (PE). Furthermore thermal pyrolysis is typically unselective.

Vollmer et al., Angew. Chemie Int. Ed. 2021, 60, 16101-16108, describe polyolefin plastic waste conversion to aromatics using an industrial Fluid Catalytic Cracking catalyst.

There remains a desire for more selective methods for the conversion of plastic materials into desired compounds, and in particular for chemical recycling methods for plastic waste materials having higher selectivity.

### SUMMARY

The invention pertains in a first aspect to a method of depolymerizing plastic material, preferably one or more types of polyolefins, in particular plastic waste material, preferably plastic waste material comprising one or more type of polyolefins, wherein the plastic material is brought in contact with a mechanical agitating part, wherein the mechanical agitating part comprises a surface exhibiting a catalytic and/or molecular material activating functionality.

The invention also pertains to grinding media having a catalytically and/or molecular material activating functionalized surface, for example having a surface provided with solid acid or base functionality and/or metal (preferably metal oxide, metal nitride, metal sulfide, metal phosphide, or metal carbide) nanoparticles. In an example embodiment, the grinding media is provided as balls for ball milling, and comprising a sulfated or tungstated metal oxide surface, in a more specific example with functionalized ZrO₂, e.g. sulfated or tungstated ZrO₂.

The invention also pertains to a method of manufacturing grinding media according to the invention, wherein the manufacturing method comprises: subjecting grinding media to a catalytic functionalization step.

The invention also pertains to a method of manufacturing grinding media for use in the inventive method of depolymerizing, wherein the manufacturing method comprises: subjecting grinding media to a catalytic functionalization step.

### BRIEF DESCRIPTION OF THE DRAWINGS

FIG. 1: Thermogravimetric analysis (TGA) to simulate pyrolysis of a model polypropylene (PP) polymer sample;

FIG. 2A: Products formed during ball milling experiment with nonfunctionalized and catalytically functionalized grinding media. A: model polypropylene (PP) (12,000 g/mol) at room temperature; B: waste PP at room temperature; C: model PP (12,000 g/mol) at 130 °C;

FIG. 2B: Cumulative yield (in mg) of the samples at room temperature (RT) of FIG. 2A.

FIG. 3: Catalytic performance of functionalized alumina grinding spheres in the pyrolysis of polypropylene (PP) measured with thermogravimetric analysis (TGA).

FIG. 4: Schematic illustration of an example embodiment with sulfated zirconia milling balls.

FIGS. 5-10 illustrate further results obtained in the examples.

Any embodiments illustrated in the figures are examples only and do not limit the invention.

### DETAILED DESCRIPTION

The invention is broadly based on the judicious insight to combine catalytic depolymerisation of plastic materials with mechanochemical cleavage of the polymer molecules in said plastic materials.

The invention also provides the novel approach of catalytically functionalizing the surface of equipment parts used for mechanically agitating the plastic material, or more broadly of functionalizing the surface of such equipment parts with a molecular functionality with chemical activity. In a particular embodiment, catalytically functionalized grinding media is used, for example for ball milling of the plastic material. The catalytic functionalization is preferably applied by a surface treatment; preferably surface-treated agitating part, e.g. surface-treated grinding media is used.

The functionalized grinding media comprise, e.g. exposed functional groups, and/or exposed metal sites, or exposed reactive groups. For instance, the surface of the grinding media comprise molecular material activating functionality.

The catalytically functionalized grinding media comprise e.g., exposed functional groups or functionalities exhibiting, e.g.,:
Brønsted acidity and/or Lewis acidity, e.g. solid acids,
solid base activity, e.g. basic sites,
(de-)hydrogenation activity,
or which are provided by e.g., metal (preferably metal oxide, metal sulfide, metal phosphide, metal carbide, and metal nitride) sites,
or combinations thereof.

These functional groups are provided, in particular, on the surface of the grinding media, and are preferably provided selectively on the surface of the grinding media. More preferably, a surface layer of the grinding media, which are e.g. milling balls, is functionalized by a treatment providing the functional groups or functionalities.

The term ‘functional group’ is used broadly and can also refer to, e.g. metal based particles or ions, and can also be referred to as ‘functionality’.

Thereby the invention provides both a plastic material depolymerisation method, which can be used for instance for recycling of plastic waste materials, as well as a new approach to combining heterogeneous catalysis and mechanochemistry. Counter-intuitively the inventive grinding media that can be used for mechanochemical processes, have a low specific surface area, e.g., are compact non-porous objects, unlike solid catalyst bodies, such as extrudates and pellets, that are typically used for existing heterogenous catalytic processes and typically have a relatively high porosity.

Without wishing to be bound by way of theory, strain induced by the mechanical agitation may induce cleavage of the polymer molecules, in particular homolytic cleavage and radical formation at lower temperatures than would occur in an equivalent non-catalytic thermal process, e.g., already at room temperature. The impacting and collision of the grinding media with the plastic material may contribute to sufficient contact between polymer molecules and catalytically active functional groups exposed on the grinding media surface such that these functional groups effectively catalyse the depolymerization reaction or stabilize formed radicals imparting control over the reaction and product selectivity.

The catalytic functional groups may provide the advantage of a relatively long lifetime of the functionalized grinding media as catalytic functional groups are not reacted away.

In addition, the impacting and collision of the grinding media with the plastic material may contribute to sufficient removal of the product molecules from the active sites freeing them for further contact with unconverted polymer. Both aspects are difficult to achieve in unagitated state of the system, because of the high viscosity of the polymers and large molecular size. Hence, the inventive method elegantly overcomes transport limitations in prior art methods thereby improving active site utilization of the catalyst.

Advantageously the invention provides in embodiments for a process for the conversion of solid plastic material into valuable chemicals such as, e.g., monomers, C1-C10 alkanes, C2-C10 alkenes, and/or aromatic compounds (e.g., C6-C10 aromatic compounds). The inventive method in particular allows to selectively target the production of monomers and short chain hydrocarbons, especially in embodiments wherein the plastic material comprises or essentially consists of polyolefins. In some embodiments, of the invention, no solvent is used. In some optional embodiments, no additional reactants are used.

The invention pertains in an aspect to a method of depolymerizing plastic material, in particular plastic waste material. The plastic material is typically a solid material at 20 °C. The plastic material is for instance provided as a granular solid material, and is e.g., provided as flakes, chips, or granules, or e.g. as powder. The plastic material is e.g. contacted with grinding media as a dry granular solid material, e.g. with solvent-free operation, and for instance under air or under a gas atmosphere, and e.g. with a gas flow.

The plastic material comprises at least one polymeric material, for instance at least 90 wt. % of one or more polymeric materials. The polymeric material comprises for instance a hydro-carbon based polymer, or for instance an organic polymer. The polymer can be e.g., a homopolymer or copolymer. Mixtures of polymers can also be used. Depolymerization for example refers to a reaction decomposing the polymer to species, e.g. monomers, or oligomers or other compounds, having a lower molecular weight than the polymer. The method may, alternatively or in addition, be referred to as a method for the conversion of a polymeric material into compound with a lower molecular weight.

Plastic waste material is broadly used to indicate non-virgin plastic material. Plastic materials, as used herein, include, synthetically produced compounds that are made from polymers.

In the method, plastic material is brought in contact with a mechanical agitating part, wherein the mechanical agitating part comprises a surface exhibiting a chemical functionality, e.g. a catalytic functionality; and is preferably surface treated to impart the functionality. The mechanical agitating part, such as e.g., grinding media, is in particular agitated in contact with the plastic material.

The contacting involves, e.g., ball milling. Ball milling is a size reduction technique that uses grinding media in e.g., a rotating cylindrical chamber, with a substantial horizontal axis of rotation. For example, the method involves ball milling of the plastic material using catalytically functionalized grinding media. In this embodiment the milling balls and the plastic material are in direct contact during the ball milling.

The mechanical agitating part, such as, e.g., grinding media, has an external surface that exhibits a catalytic functionality and that is in particular modified with catalytic functional groups. Thereby the surface preferably has a different composition than the bulk of the grinding media.

The method comprises in a preferred embodiment introducing the plastic material in a reactor (e.g. a container or vessel, or more broadly a reaction zone) and introducing the grinding media into the reactor, and contacting the plastic material and the grinding media with each other under agitation in the reactor. The grinding media has an external surface that exhibits a catalytic functionality, and that is in particular modified with catalytic functional groups, before it is introduced into the reactor, and before it is contacted with the plastic media. The step of introducing functionalized grinding media into the reactor can refer to a batch operation and to a step of continuously introducing functionalized grinding media into a continuous reactor. The process for example comprises withdrawal of used grinding media from the reactor, re-generating the grinding media, e.g. by providing the catalytic functionality, e.g. by sulfating the grinding media, and re-introducing the regenerated grinding media, which have the external surface with catalytic functional groups, into the reactor. The re-generation step is for example carried out using the inventive preparation methods. Hence, a preferred method involves both the depolymerization method and, separately, regenerating the grinding media using the preparation method; wherein the depolymerization and the regeneration are carried out e.g. in separate reactors. In the invention, the catalytic functionality of the grinding media is preferably not, or not exclusively, formed in situ by the contact with the plastic material.

In a further embodiment, reactor parts are catalytically functionalized, e.g. the walls, a stirrer, or an extrusion screw of the reactor, and the polymeric material is introduced into the reactor having the functionalized reactor part and the reaction products are withdrawn from the reactor.

Preferably, the plastic (waste) material comprises polyolefins, such as e.g., polyethylene, polypropylene, or their mixture, as well as different types, including the corresponding multilayer plastic materials made thereof. Preferably, the plastic (waste) material comprises at least 10 wt. % polyolefin, or at least 50 wt. % or at least 70 wt. % or at least 90 wt. % of one or more polyolefins, preferably at least 70 wt. % or at least 90 wt. % of polyethylene or of polypropylene. As shown in the examples, the inventive method can be used advantageously for depolymerization of polyolefins, such as polypropylene, with the targeted formation of monomers and short-chain hydrocarbons.

In further embodiments, the plastic (waste) material may comprise one or more polymers selected from the group consisting of polystyrene, acrylonitrile butadiene styrene copolymer, polyesters, polycarbonates, polyamides, polymethyl(meth)acrylate, or polyvinyl chloride. The material may also comprise, e.g., synthetic rubbers, such as styrene-butadiene rubbers.

The plastic (waste) material may optionally comprise additives, such as, e.g., colorants, stabilizers, plasticizers, lubricants and flame retardants, nucleating agents, compatibilizers, impact modifiers, rheology modifiers, processing aids, and antimicrobial additives, among others. Optionally, the plastic (waste) may further comprise fillers, residual catalyst and/or initiator. In particular in case of plastic waste material, the material may comprise one or more of said additives and further components. The plastic material, in particular plastic waste material, may also comprise two or more types of polymers.

In the method, the plastic (waste) material is brought in contact with a mechanical agitating part. The mechanical agitating part comprises a surface exhibiting a catalytic functionality; preferably is surface treated to provide the surface with the functionality.

In some embodiments, the mechanical agitating part is an equipment part, e.g., a grinding disc, grinding wheel, or extrusion screw. In other embodiments, the mechanical agitating part with catalytically functionalized surface is provided by catalytically functionalized grinding media, such as for instance milling balls. A combination of two or more types of mechanical agitating parts with catalytically functionalized surfaces is also possible. The catalytically functionalized surface may exhibit two or more types of catalytic functionality. Typically, the surface exhibits catalytically active functional groups. The catalytic functionality is, typically, depolymerization activity, more in particular for depolymerization of the type of plastic material used. Hence, typically, the catalytic functionality matches the type of polymer to be depolymerized.

In some embodiment, the mechanical agitating part is provided by grinding media. The grinding media is for instance balls, for example grinding balls. Other suitable types of grinding media shapes include, e.g., cylpebs (slightly tapered cylindrical grinding media), rollers, and bars, and satellites. Other types of grinding media are also possible. Grinding media are usually granular solid objects that can move freely in a reactor.

The method is preferably carried out in a reactor, for instance a batch or continuous reactor, comprising a reactor space for holding the plastic material, and an agitating device, such as a motor, for agitating the grinding media and/or the mechanical agitating equipment part. The reactor is, e.g., a rotating chamber which can be used with balls as grinding media.

The grinding media has, for example, a density of at least 3.0 g/cm³ or at least 4.0 g/cm³ (solid bulk density), higher values are also possible. The grinding media solid objects for example, without limitation, have a smallest dimension of at least 1.0 mm or at least 5.0 mm. For instance, grinding balls may have a diameter of e.g., 20 mm to 150 mm.

In preferred embodiments, the grinding media comprises, or substantially consists, e.g., for more than 90 wt. % of, e.g., zirconia, alumina, steel, and/or tungsten carbide. Other materials are also possible. In some embodiments, the grinding media comprises, e.g., for at least 90 wt. %, of one or more of metals, metal oxide, metal carbide, and metal nitride. For instance, ceramic materials are suitable; i.e. inorganic, non-metallic oxide, nitride, or carbide material. Ceramic materials may be advantageous as they are often hard, brittle, heat-resistant and corrosion-resistant.

Advantageously, the grinding media is catalytically functionalized. In particular, the grinding media is preferably surface modified to impart the functionality, in particular to impart the catalytic functional groups. Accordingly, the functional groups, in particular catalytic functional groups, are preferably selectively present on the surface of the grinding media elements, relative to the core of the grinding media elements (e.g., selectively present on the surface of milling balls). For example, optionally, the grinding media (e.g. milling balls) have an outer layer, e.g. a shell, having a higher concentration of the catalytic functional groups; the depth of the layer is, optionally, e.g., less than 1.0 mm, or less than 0.5 mm.

The catalytic functionalization can also be provided by a surface treatment of the grinding media to increase or enhance an existing functionality of the surface groups of the grinding media. Preferably, the grinding media preparation involves a catalytic functionalization step that introduces or enhances catalytic functionality of the surface of the grinding media, by a modification of the surface of the grinding media, in particular of the composition of the surface. Preferably, the surface of the grinding media has a different composition than the inner parts of the grinding media. These and the following preferences apply equally for equipment parts as the agitating parts.

The catalytic functionality is, e.g., Brønsted acidity and/or Lewis acidity, (de-)hydrogenation activity, or (solid) base activity, or is provided by metal sites, e.g. metallic nanoparticles, including combinations thereof; wherein the metallic nanoparticles are optionally provided as, e.g., metal oxide, metal nitride, metal sulfide, metal phosphide, or metal carbide.

In one embodiment, the grinding media functionalization imparts or increases solid acid functionality, in particular, Brønsted acid and/or Lewis acid, functionality, in particular of the surface of the grinding media; more preferably both Brønsted acid and Lewis acid functionality, e.g. by sulfating or other treatment of metal oxide grinding media. Such functionalization is particularly advantageous for the plastic waste material comprising polyolefins; for instance, for catalysing cracking reactions of polyolefins.

In a particular embodiment, the catalytic functionality is provided by sulfated metal oxides; or sulfated metal nitride, metal sulfide, metal phosphide, or metal carbide. This may provide for strong acid catalytic functionality. For instance, sulfated ZrO₂, Fe₂O₃, TiO₂, SiO₂, or Al₂O₃ can be used, though other sulfated metal oxides are also possible; as well as sulfated metal nitride, or metal carbide, or metal sulfide, metal phosphide.

The theoretical monolayer coverage for isolated SO₄ sites on a ZrO₂ support has been reported to be estimated as ~4 SO₄/nm² (4×10³ SO₄/1000 nm²), and a saturation coverage of sulfate on ZrO₂ of ~2.3 SO₄/nm² (2.3×10³ SO₄/1000 nm²) was reported as measured with a thermobalance (Yan et al., Appl. Cat. A 572 p. 210-225 (2019)). Without wishing to be bound by way of theory, it is proposed that in some embodiments of the present invention, the density of SO₄ sites on grinding media, preferably ZrO₂ support, could be, optionally, at least 50 SO₄/1000 nm²; or at least 100 SO₄/1000 nm²; or at least 500 SO₄/1000 nm². These densities could be used as an optional lower limit indicative of at least some effective sulfating treatment; desirably good sulfation is achieved when preparing the grinding media. More broadly, the density of solid acid sites, could, optionally, be at least 50, or at least 100, per 1000 nm², in some embodiments of the invention. The surface area in nm2 could be measured with N₂ adsorption (BET), and using an appropriate thin sample taken from the outer surface of grinding media (e.g. with a depth of less than 0.10 mm). The number of SO₄ or other type of acid sites could be measured with temperature programmed desorption of a small alkaline molecule, e.g. NH₃ or an amine. These optional acid site densities optionally are specified as features of all aspects of the invention.

In a further embodiment, the functionalization is provided by chlorination of a metal-based support, e.g. metal oxide support (surface), in particular by chlorinated alumina. This may provide for strong solid acid functionality.

In yet a further embodiment, the functionalization is provided by silica alumina, which may provide for strong solid acid functionality. For example, alumina grinding media is functionalized with silica groups, or silica grinding media is provided with alumina groups

Another possible functionalization is functionalization of ZrO₂ grinding media with tungsten oxide species, e.g. tungstated ZrO₂. This may provide for strong solid acid functionality.

The metal oxide grinding media preferably exhibit surface hydroxyl groups.

In another embodiment, the grinding media functionalization is with metals or metal alloys, e.g., as nanoparticles, such as e.g., Ni, Fe, and V. These example metals may assist in (de)hydrogenation. This could be advantageous for example for plastic waste material comprising polyolefin. Also possible are Ru, Pd, Pt, and Ni, in particular as nanoparticles, which can be used for hydrogenolysis.

In yet another embodiment, the grinding media functionalization is with metallic nanoparticles or mixed metal oxides, such as e.g., Mn, Co, Mg, and Zn. This is advantageous for example for plastic waste material comprising polyesters, in particular polyethylene terephthalate, such as with hydrolysis.

In another embodiment, the grinding media functionalization is to provide alkaline functionality (i.e. solid base), e.g., by CaO on alumina. Hence, in a possible embodiment, the catalytic functionality is provided by solid base groups. Some examples of solid base (alkaline) functionalities include alkaline earth oxides, alkali metal oxides, rare earth oxides, zeolites, supported alkali metal ions, or e.g. nitrides on zeolite; these functionalities can be applied to e.g. grinding media as support.

In yet another embodiment, the catalytic functionalization could comprise metal nitride, sulfide, phosphide, or carbides. For example, MoC could be used as dehydrogenation or dehydro-oxygenation catalyst.

It is to be mentioned that the discussed types of catalytic functionalization can be combined with each other, e.g., metal nanoparticles in combination with solid acid functionality or with alkaline functionality. Alkaline functionality respectively acid functionalization can be beneficial for depolymerisation of polyesters. Furthermore, the catalytic functionalization can be applied not only to grinding media, but also to reactor parts as agitating parts.

As shown in Example 2, catalytic functionalization can provide for increased yield of the gaseous products, such as C1-C6 alkanes. Additionally, upon functionalization grinding media beneficially decreases the temperature of maximum decomposition, by e.g., approx. 10-50 °C as shown in Examples 1 and 4.

In a preferred embodiment, which does not limit the invention, the grinding media comprises a surface comprising a sulfated metal oxide. For example, the sulfated metal oxide is sulfated zirconia or sulfated alumina. Advantageously, sulfated zirconia exhibits catalytic activity in plastic cracking, such as e.g., decrease of the temperature of maximum decomposition by approx. 50 °C, as shown in Example 1. Moreover, the use of sulfated zirconia as a grinding media leads to significant increase in C1-C10 product formation already at room temperature compared to unfunctionalized grinding media, as shown in Example 2 for model and waste PP. By virtue of a synergy of catalytic and the mechanochemical effects, a fourfold increase in the initial propene formation rate and increased total C1-C10 product formation were observed. Sulfated zirconia illustrates solid acid catalytic functionality, in particular of sulfated metal oxide.

In some embodiments of the inventive method, the depolymerization is carried out at a temperature above the glass transition temperature (T_{g}) of the plastic material. Thereby certain embodiments of the method depart from prior art methods wherein plastic material is milled below the glass transition temperature of the plastic material. However, it is also possible in the inventive method that the depolymerisation is carried out at temperatures below the glass transition temperature.

The glass transition temperature is determined using e.g., differential scanning calorimetry according to, e.g., ISO 11357-2: 2020. In embodiments of the inventive method, the depolymerization is performed at a temperature for example above −196 °C and/or below 600 °C, such as a temperature below 400 °C, or up to 300 °C, such as 0 °C to 300 °C, such as, e.g., from 20 °C to 250 °C or to 300 °C; for instance for PP and PE. The reaction may in particular be performed below the (non-catalytic) thermal cracking temperature of the polymer. For example, catalytic grinding of PP can be advantageously performed at e.g., 130 °C. In this particular embodiment (see Example 2), the monomer formation initially increased by a factor of 25 compared to milling at room temperature and total C1-C10 product formation was significantly increased. Additionally, catalytic grinding at elevated temperature advantageously leads to more selective plastic depolymerization yielding high amounts of the basic building blocks of said polymer.

The depolymerization generally involves cleavage reactions and may involve, e.g., cracking, or e.g., hydrogenolysis (cleavage using hydrogen as reactant) or hydrolysis (cleavage using water as reactant). The catalytic functionalization is for example to provide catalytic functionality to one or more of these reactions.

The method of the invention furthermore advantageously permits for easy recovery of the catalyst from the product, in particular from a gaseous product stream. Accordingly, the grinding media can be easily kept in a batch or continuous reactor. The grinding media may also provide for maintaining the structural integrity of the catalytic component during the mechanochemical process.

The use of a surface modification to impart catalytic functionality furthermore permits advantageous regeneration of the catalyst in case of, e.g. attrition or catalyst deactivation. For instance, the method may involve separating spent (i.e. used) grinding media from the reaction mixture (e.g. by withdrawal of the reaction mixture from a reaction zone) and subjecting the spent (used) grinding media to regeneration, e.g., by the process used for catalytic functionalization of the grinding media, such as sulfation.

The method of the invention permits for solvent-free operation in preferred embodiments, e.g., using less than 10 vol. % or less than 1.0 vol. % solvent, relative to plastic material, or without solvent.

The high shear and vigorous movement of the grinding media may help to avoid clogging of the reactor. Such clogging can occur in comparative fluidized bed reactors, in particular because of the high viscosity of the molten plastic material. The vigorous movement of the grinding media may also contribute to a more even temperature profile of the reactor, which is important because the thermal conductivity of plastic is relatively low.

The invention also provides for grinding media having a catalytically functionalized surface, that are e.g., suitable for the inventive depolymerization method, and/or for other catalytic processes. The preferences for the grinding media, including the material and the catalytic functionalization as discussed for the method, apply equally for the grinding media. For instance, the grinding media is e.g., provided as balls, cylpebs (slightly tapered cylindrical grinding media), rollers, satellites, or bars.

The grinding media is for instance a surface-modified metal oxide part. The grinding media has, for example, a density of at least 3.0 g/cm³ or at least 4.0g/cm³. The grinding media solid objects for example, without limitation, have a smallest dimension of at least 1.0 mm or at least 5.0 mm. For instance, grinding balls may have a diameter of e.g., 20 mm to 150 mm. In some embodiments, the grinding media functionalization is with solid acid, Brønsted acid, Lewis acid, or a combination of thereof, e.g. solid acid functionality with both Brønsted acid surface groups and Lewis acid surface groups. The grinding media are for instance surface-modified ceramic grinding media. In a preferred embodiment, the grinding media are sulfated metal oxide grinding media. In an embodiment, the grinding media comprise a metal oxide shell (outer layer), which shell is provided with a catalytic functionalization, e.g. grinding media with a metal oxide shell or layer that is subjected to a treatment to functionalize the surface, e.g. to sulfation. As an example, sulfated ZrO₂ on surface-oxidized tungsten carbide can be mentioned.

Also provided is method of manufacturing grinding media (i.e., a preparation method), in particular for the preparation of the inventive grinding media, the method comprising: subjecting grinding media to a catalytic functionalization step. The catalytic functionalization step preferably introduces or enhances solid acid functionality and/or provides metal nanoparticles on the grinding media surface. The method gives catalytically functionalized grinding media. The manufacturing method can be equally applied to a reactor component as the agitating part, to provide a catalytically functionalized reactor component.

Preferably, the grinding media are provided with solid acid functionality, e.g. are sulfated, e.g. by treatment with sulfuric acid, for example at above 400 °C. More preferably, metal oxide, nitride, or carbide, milling balls are sulfated. For example, zirconia or alumina grinding balls are sulfated, to impart solid acid catalytic functionality. Preferably, the untreated grinding media comprise surface hydroxyl groups. Optionally, the treated grinding media comprise remaining surface hydroxyl groups, e.g. with metal oxide grinding media.

In a preferred embodiment of the preparation method, the method involves sulfation of grinding media, and the method comprises contacting the grinding media with liquid sulfuric acid at a temperature range lower than the boiling temperature of sulfuric acid, e.g. in the range 100 °C to 350 °C, to cause sulfation and etching, subsequently removal of the liquid phase, in particular removal of the sulfuric acid, preferably by via evaporation and/or decomposition, and thereafter, at a higher temperature than the boiling temperature of sulfuric acid, annealing of the grinding spheres, in the presence of a gas, e.g. a gas flow. The boiling point of sulfuric acid can be taken as 350 °C, and is higher than the decomposition temperature (about 300 °C).

During the heating ramp, the decomposition (>300 °C) and boiling points of sulfuric acid (~350 C) are surpassed. Therefore, during an initial phase at lower temperature, the grinding spheres are subjected to hot liquid sulfuric acid and decomposition products, while afterwards, they are subjected to a higher temperature and a gas atmosphere, for instance a gas flow (optionally comprising O2 and/or N2) during the annealing. For example, individual sulfate groups can condense at elevated temperature to form more Lewis-acidic pyrosulfate species during the annealing.

In an example embodiment of the preparation method, the grinding media, e.g. metal oxide grinding media, are treated with sulfuric acid (e.g. at least 95%), at a treatment temperature of at least 400°, or at least 600 °C, or more preferably 700-900 °C, for a duration of at least 0.5 hours, at least 1.0 hour, and for example with a heating from a temperature below 50 °C (e.g. from ambient) to a temperature of 350 °C in more than 10 minutes or more than 20 minutes, and with further heating from 350 °C to said temperature in more than 10 minutes or more than 20 minutes.

All preferences for the grinding media apply also for the method of manufacturing grinding media. The manufacturing method can also be referred to as a method of preparing grinding media or a method of treating grinding media. The prepared grinding media can be used in the inventive method of depolymerizing plastic material. Preferably, the method of depolymerizing plastic material uses grinding media obtained or obtainable with the preparation method. For example, the depolymerization method uses sulfated grinding media.

The inventive grinding media are preferably obtainable by the preparation methods. The inventive depolymerisation method preferably uses grinding media obtainable by, or obtained by, the preparation methods.

In another embodiment, metal nanoparticles are deposited on the grinding media, in particular on metal oxide grinding media. In some embodiments, metal nanoparticles deposition and imparting solid acid functionality are combined.

In a further embodiment, a preparation method is used that involves a treatment of reactor parts to provide a catalytic functionality, e.g. treatment of the the walls, a stirrer, or an extrusion screw of the reactor, or of another part of the reactor; for instance a sulfation treatment of the reactor part or a treatment to deposit metal or metal-based nanoparticles.

The invention also provides a method that comprises manufacturing catalytically functionalized grinding media, or reactor component, using the inventive manufacturing method, and subsequently depolymerizing plastic material, using the inventive depolymerization method and using the prepared grinding media or reactor component.

### EXAMPLES

The invention will now be further illustrated by the following non-limiting examples. These examples do not limit the invention and do not limit the claims.

### Example 1

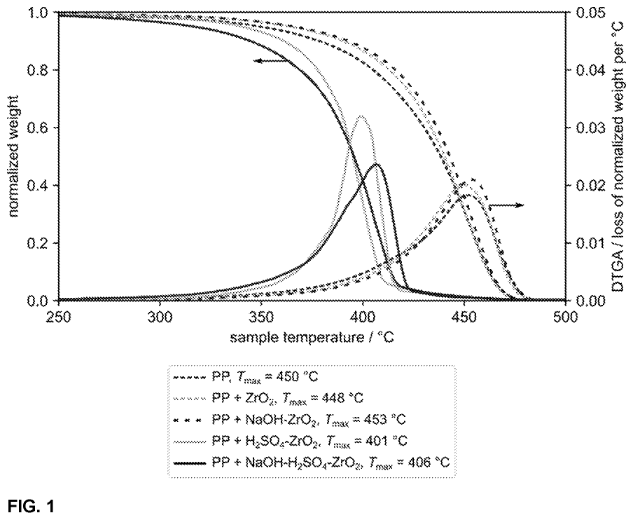

To test the general catalytic activity of the prepared grinding media, thermogravimetric analysis (TGA) was used to simulate pyrolysis of a model polypropylene (PP) polymer sample (Sigma-Aldrich, Mₙ=5,000 g mol⁻¹, M_{w}=12,000 g mol⁻¹). TGA results are shown in FIG. 1. Without grinding media, the temperature of maximum weight loss was about 450 °C; with untreated ZrO₂ grinding media about 448 °C and with sulfated ZrO₂ grinding media it was lowered to about 401 °C. The onset temperature was above 300 °C. The commercially available zirconia (ZrO₂) grinding media were balls (spheres) with 3 mm diameter (Retsch®, yttrium partially stabilized zirconium oxide, 94.5% ZrO₂, 5.2% Y₂O₃). The sulfated grinding media were obtained by sulfuric acid treatment at 650 °C for 5 h (heating rate: 2.5 °C min⁻¹). 95 wt. % sulfuric acid was used in all examples. In the examples, the sulfation treatment involves heating the grinding media in contact with sulfuric acid to a temperatures above the evaporation/decomposition temperatures of H₂SO₄ and further heating at these higher temperature under an air stream (in example 1: 650 °C for 5 h).

After cooling to room temperature, the balls were washed with deionized water until pH neutrality and dried in air. Etching with NaOH, if used, was performed for 3 h in molten NaOH at 425 °C (heating rate: 2 °C min⁻¹). TGA was performed in a static, non-moving crucible with relatively low contact area between grinding media and polymer and using approx. 10 mg polymer material in a presence of one grinding ball, wherein the sample was heated from 50 °C to 600 °C using a heating rate of 10 °C min⁻¹ under a N₂ flow. The temperature of maximum weight loss decreases from about 450 °C for polymer alone to around 400 °C when adding the catalytically functionalized spheres. This effect was observed with both strategies involving sulfuric acid treatment, while simple NaOH etching alone had no effect.

### Example 2

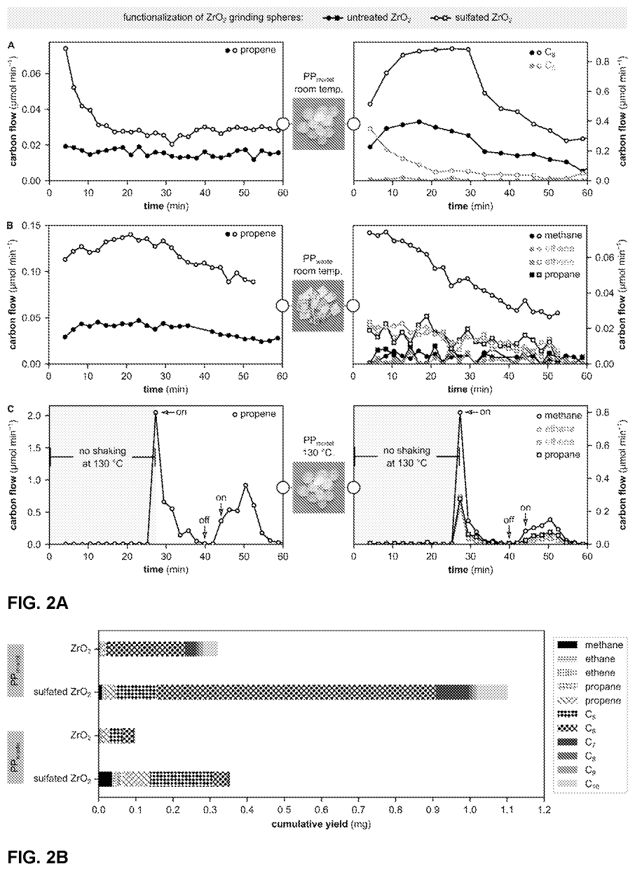

To demonstrate catalytic activity of the prepared grinding media during ball milling, the experiment was performed with 2 g polypropylene (PP) pellets, model PP (Sigma-Aldrich, Mₙ=5,000 g mol⁻¹, M_{w}=12,000 g mol⁻¹) or waste PP (sourced from a food container, purchased at a supermarket) was loaded into a 25 ml tungsten carbide (WC) ball milling container (Retsch®) and 5 ZrO₂ grinding (acid functionalized) spheres were added (estimated surface area of 0.0016 m²). Grinding spheres (Retsch®, yttrium partially stabilized zirconium oxide, 94.5% ZrO₂, 5.2% Y₂O₃, 10 mm diameter) were either used as such or were sulfated using sulfuric acid according to the procedure described in Example 1. The container was shaken using a Retsch® MM 400 Mixer Mill at room temperature (RT, approx. 21 °C) and at 130 °C, for 60 minutes at a frequency of 30 Hz, after which the milled material was collected for further analyses. Products were eluted from the milling chamber using a flow of 50 ml min⁻¹ N₂ as a carrier gas. Product analysis was performed using an online gas chromatograph (GC) equipped with a thermal conductivity detector (TCD) and a flame ionization detector (FID). The formation of products is reported as carbon μmols per minute. The profiles of the formed products are shown in FIG. 2A. Advantageously, significant amounts of products could be observed already at RT, compared to the onset temperature above 300 °C in Example 1 with static conditions, indicating the synergy of catalytic and mechanochemical effects. Moreover, a significant increase in C1-C3 product formation is obtained by using functionalized grinding media. With model PP, no C1-3 products except for the monomer propene were detected (panel A). With waste PP, only C1-3 products were detected (panel B). A fourfold increase in initial propene formation rate was observed with the functionalized grinding media; and C1-3 product formation was detected which is negligible over unfunctionalized

The experiments with model PP were also carried out at 130 °C (panel C). After 40 minutes, the shaking was turned off and no products were observed. No C1-3 products were formed over the unfunctionalized grinding media. With the sulfated grinding media, propene formation initially increased by a factor of 25 compared to milling at RT and C1-3 products started to appear. FIG. 2B shows the cumulative yield in mg of the samples at RT, i.e., of panels A and B of FIG. 2A.

### Example 3

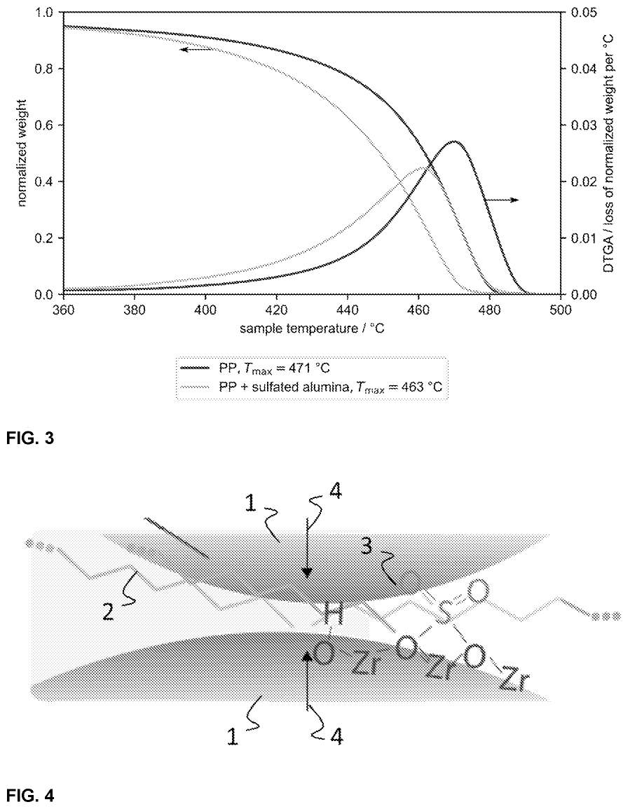

In another embodiment, sulfated alumina grinding media were used. Commercial grinding balls (2 mm diameter, 94% Al₂O₃, Union Process) were submerged in concentrated sulfuric acid (H₂SO₄, VWR) in a quartz crucible which was then heated to 650 °C for 5 h with a heating rate of 2.5 °C min⁻¹ in a tubular oven. After cooling to room temperature, the balls were washed with deionized water until pH neutrality and dried in air. To evaluate catalytic activity initially without grinding, TGA analysis was used to simulate catalytic cracking as described in Example 1; results are shown in FIG. 3. The temperature of maximum weight loss decreases from about 471 °C for polymer alone to around 463 °C when adding the catalytically functionalized spheres.

### Example 4

In an example embodiment as schematically illustrated in FIG. 4, milling balls (1) can be used for the depolymerization of polymers (2), such as polyolefins. The ZrO₂ milling balls are treated, e.g., sulfated (3), to enhance solid acid catalytic functionality. The vigorous motion (4) (arrows) during milling and the catalytic functionality synergistically contribute to the depolymerisation.

### Example 5

The effect of the milling frequency on the propene production rate is demonstrated, using sulfated ZrO₂ grinding spheres and PP.

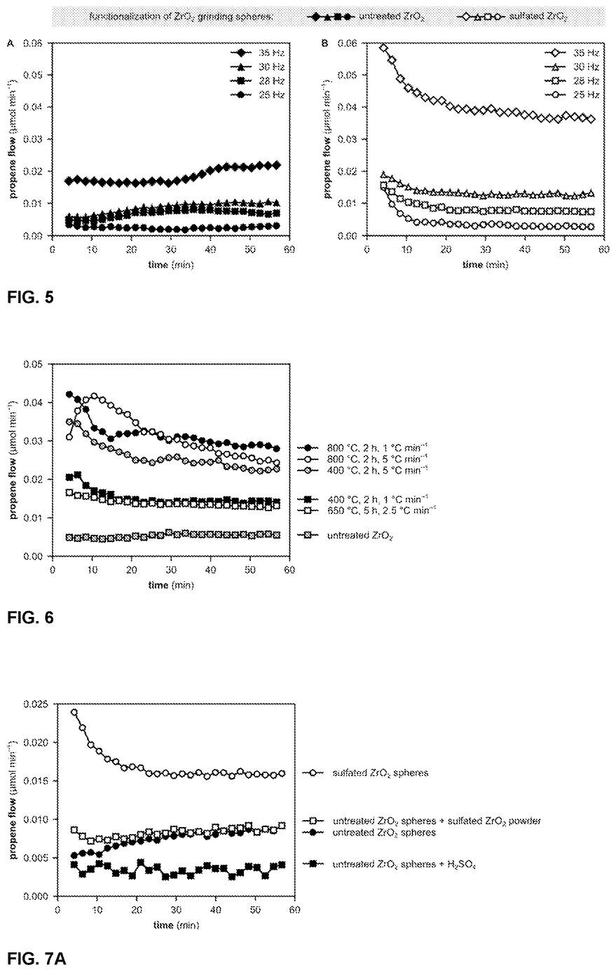

The propene production rate can be boosted by increasing the milling frequency, see FIG. 5.

FIG. 5 shows the propene yields generated by milling of model PP with untreated (FIG. 5A) and sulfated (FIG. 5B, treatment with H₂SO₄, 650 20 C, 2.5 °C min⁻¹, 5 h) grinding spheres at (from bottom to top) 25, 28, 30, and 35 Hz are shown.

For ball milling experiments in Examples 5-9, the following procedure is typical: 2 g polypropylene (PP) pellets (Sigma-Aldrich, Mₙ=5,000 g mol⁻¹, M_{w}=12,000 g mol⁻¹, denoted as model PP or PPmodel) were loaded into a 25 ml tungsten carbide ball milling container (Retsch®). Grinding spheres with a diameter of 10 mm were used for ball milling experiments. For experiments with polyethylene (PE), 2 g of an industrial sample of unstabilized PE powder with a melt flow index of 7.33 dg min⁻¹ (measured at 190 °C and 21.6 kg) were used. For experiments with polystyrene (PS), 2 g pellets (Sigma-Aldrich, M_{w}=192,000 g mol⁻¹) were used. The container was closed hand-tight using a Teflon seal and shaken using a Retsch® MM 400 or Retsch® MM 500 vario Mixer Mill for a given time at a frequency of 30-35 Hz. The grinding jar was equipped with 1/16 or ⅛″ elbows welded to the container. Holes were drilled into the commercial container via electrical discharge machining. Products were eluted from the milling chamber using a flow of 12.5 or 50 ml min⁻¹ N₂ as a carrier gas and internal standard. Product analysis was performed using an online Global Analyser Solutions gas chromatograph (GC).

The surface functionalization of zirconia grinding spheres was performed with sulfuric acid using a tubular furnace which was operated with a heating ramp to reach a dwell temperature (≥400 °C) which was then held for sufficient time. During the treatment, sulfation, etching, and the formation of active surface sites take place. During the heating ramp, the decomposition (>300 °C) and boiling points of sulfuric acid (~350 °C) are surpassed. Therefore, during an initial phase at lower temperature, the grinding spheres are subjected to hot liquid sulfuric acid and decomposition products, while afterwards, they are subjected to a higher temperature and air.

The sulfation treatment in the examples is carried out in a tubular furnace. An open vessel with sulfuric acid (95%) and the grinding spheres sits in a cylindrical tube, and a stream of air (e.g. 100 ml/min) is supplied through the tube from one side to the other thereby withdrawing evaporated sulfuric acid and decomposition products during the treatment.

These two phases translate to two important regimes during the functionalization procedure: the sulfation and etching<T_{boil} and T_{decomp} of sulfuric acid, and, after removal of the sulfuric acid via evaporation/decomposition, changes in surface chemistry due to the annealing of the grinding spheres in the oven.

During the first step, sulfuric acid decomposes to sulfur oxides (SO₂ and SO₃), besides H₂O. These in-situ formed highly reactive gases create acidic functionality on the outer surface of ZrO₂ grinding spheres. They can react with surface hydroxyl groups of ZrO₂ to form, among others, surface sulfate species, which generates both surface Lewis-and Brønsted acid sites. Furthermore, hot sulfuric acid etches the grinding spheres and roughens their surface, which is beneficial for a catalytic application due to the increased surface area. The second step, i.e., the heat treatment after surpassing the evaporation/decomposition temperature affects the nature of sulfurous surface species. For example, individual sulfate groups can condense at elevated temperature to form more Lewis-acidic pyrosulfate species.

### Example 6

Various high-temperature treatments with sulfuric acid are illustrated.

Heating rates between 1 and 20 °C min⁻¹ were used, temperatures between 400 and 900 °C, and dwell times between 1 min and 6 h. All tested spheres were catalytically active, with a good performance after treatment at 800 °C, for 2 h, with a heating rate, from ambient to 800 °C, of 5 °C min⁻¹. Results are shown in FIG. 6, showing the propene yields generated by milling of model PP with untreated and sulfated ZrO₂ grinding spheres. During the high-temperature treatment with sulfuric acid, different heating rates, temperatures, and dwell times were used.

### Example 7

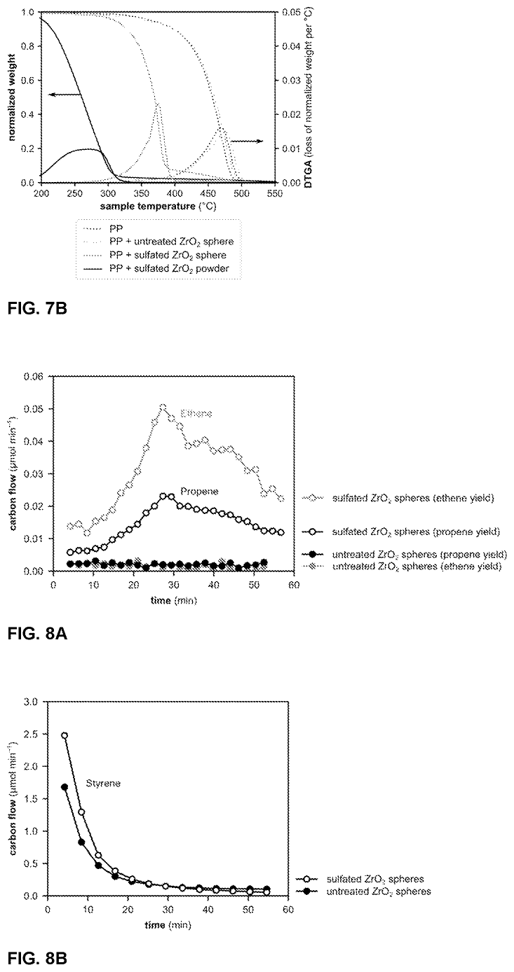

To underline the necessity of functionalizing the grinding spheres, comparative experiments were performed where sulfated ZrO₂ was added as a powder or sulfuric acid as a liquid (FIG. 7A). Despite high thermo-catalytic activity during thermogravimetric analysis (TGA) (FIG. 7B) and an extremely high surface area compared to the grinding spheres (10 m² for 100 mg powder vs. 0.0016 m² for 5 spheres without accounting for surface roughness), sulfated ZrO₂ as a powder additive does only have a negligible effect on propene production. Thus, the immobilization of catalytic sites on the surface of the grinding spheres is necessary to achieve satisfactory activity. Adding liquid sulfuric acid does not boost the propene formation, but quenches it almost completely (FIG. 7A).

FIG. 7A shows propene flow during milling of model PP with only untreated ZrO₂ grinding spheres (filled circles), only sulfated (H₂SO₄, 650 °C, 2.5 °C min⁻¹, 5 h) ZrO₂ grinding spheres (open circles), untreated ZrO₂ grinding spheres with 100 mg sulfated ZrO₂ powder (open squares), and untreated grinding spheres with 5 drops of liquid H₂SO₄ (filled squares).

FIG. 7B shows TGA results of model PP (black dotted) (comparative) and model PP with untreated ZrO₂ (grey dotted) (comparative), sulfated ZrO₂ spheres (grey line, H₂SO₄, 650 °C, 2.5 °C min⁻¹, 5 h), sulfated ZrO₂ powder (comparative) (black line).

### Example 8—Activity of Sulfated ZrO₂ for Polyethylene and Polystyrene

To illustrate the broader scope of plastic that can be processed with the inventive method, this example shows catalytic activity of sulfated ZrO₂ spheres on the degradation of polyethylene (PE) (FIG. 8A) and polystyrene (PS) (FIG. 8B) to, among others, their monomers. Polyethylene was milled at 35 Hz using sulfated and untreated ZrO₂ grinding spheres. The negligible amounts of ethene and propene generated when milling with untreated grinding spheres were significantly increased through the use of sulfated ZrO₂ spheres, see FIG. 8A.

FIG. 8A shows ethene and propene yields generated by ball milling of model PE with untreated (filled circles) and sulfated (H₂SO₄, 800 °C, 5 °C min⁻¹, 2 h, empty circles) grinding spheres at 35 Hz.

FIG. 8B shows styrene yields generated by ball milling of PS with untreated (filled circles) and sulfated (H₂SO₄, 800 °C, 5 °C min⁻¹, 2 h, empty circles) grinding spheres at 30 Hz.

### Example 9

Additional combinations of activated grinding spheres were tested, with satisfactory results, as mechano-catalysts: sulfated alumina, respectively tungstated ZrO₂, as further illustrated below.

Additional good results were also obtained for zeolite on alumina, and sulfated ZrO₂ on surface-oxidized tungsten carbide. TGA results for these samples indicate a successful catalytic treatment (not shown).

### Sulfated Alumina

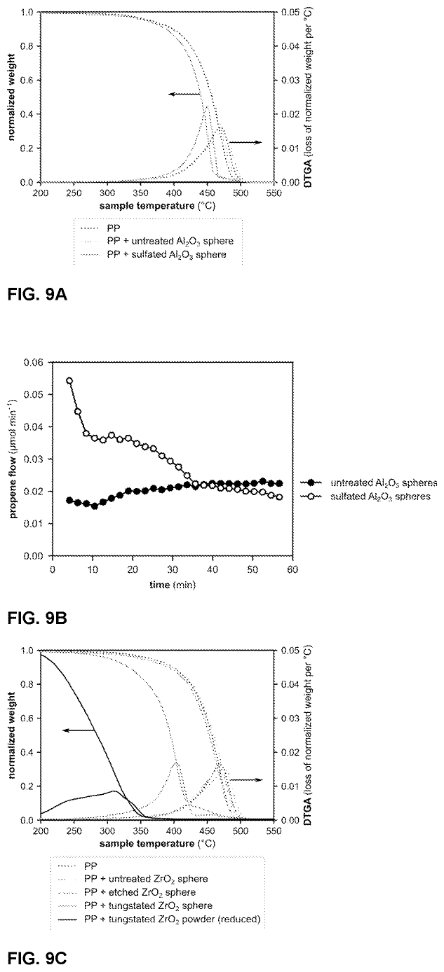

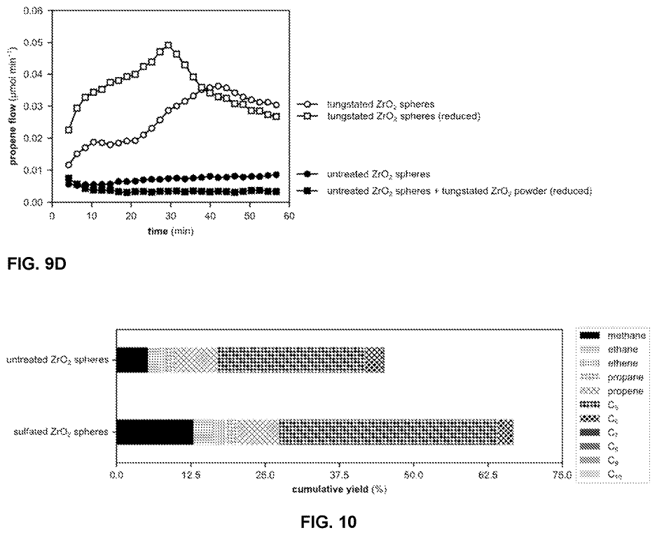

For sulfated alumina, a catalytic effect on propene production for ca. 30 min is observed after which the curves for sulfated and untreated Al₂O₃ are superimposed (FIG. 9A).

FIG. 9A shows thermogravimetric analyses of model PP (black dotted) and model PP with untreated Al₂O₃ (grey dotted) (comparative) as well as with sulfated Al₂O₃ (grey line).

FIG. 9B shows propene monomer yields generated by ball milling of model PP with untreated (filled circles) (comparative) and sulfated (H₂SO₄, 800 °C, 5 °C min⁻¹, 2 h, empty circles) grinding spheres at 35 Hz.

### Tungstated ZrO₂

Tungstated ZrO₂ grinding spheres boost propene formation rates in comparison to untreated zirconia spheres. The catalyst performance can be improved by using a reductive treatment in H₂ at 450 °C prior to use. Furthermore, a reduced tungstated ZrO₂ powder catalyst was tested (comparative example). Despite high thermo-catalytic activity during TGA, tungstated ZrO₂ as a powder additive (comparative example) does not increase propene production, underlining the advantages of functionalizing the grinding spheres directly.

FIG. 9C shows thermogravimetric analyses of model PP (black dotted) (comparative) and model PP with untreated ZrO₂ spheres (grey dotted) (comparative), etched ZrO₂ spheres (grey dashed) (comparative), tungstated ZrO₂ spheres (grey line), and tungstated ZrO₂ powder after reduction at 450 °C (comparative) (black line).

FIG. 9D shows propene yields generated by ball milling of model PP with untreated (filled circles) (comparative) and tungstated ZrO₂ grinding spheres at 30 Hz. Tungstated ZrO₂ grinding spheres were either tested directly after calcination (empty circles), or after an additional subsequent reduction in H₂, performed at 450 °C (empty squares). In a comparative example, reduced tungstated ZrO₂ powder was used together with untreated ZrO₂ grinding spheres (filled squares).

### Example 10

As an addition to Example 5, FIG. 10 shows the results of experiment demonstrating that that high frequencies of milling in combination with an adjusted ratio of plastic to grinding spheres can be used to maximize the obtained yields. When milling 20 mg of model PP for 1 h at 35 Hz, cumulative yields of 45% and 67% can be obtained with untreated and sulfated grinding spheres (heating program: 800 °C, 2 h, 5 °C min⁻¹), respectively.

1. A method of depolymerizing plastic material, the method comprising the plastic material with a mechanical agitating part, wherein the mechanical agitating part comprises a surface exhibiting a catalytic functionality.

2. The method according to claim 1, wherein the method involves depolymerization of a polyolefin.

3. The method according to claim 1, wherein the plastic material is brought in contact with grinding media as said mechanical agitating part, wherein the grinding media comprises a surface that is modified with catalytic functional groups.

4. The method according to claim 3, wherein the catalytic functional groups are selectively present on the surface of the grinding media.

5. The method according to claim 3, wherein the method involves ball milling of the plastic material using said grinding media.

6. The method according to claim 1, wherein the catalytic functionality is Brønsted acidity and/or Lewis acidity.

7. The method according to claim 6, wherein the catalytic functionality is a solid acid functionality.

8. The method according to claim 7, with grinding media as said mechanical agitating part, wherein the grinding media exhibits a surface comprising a sulfated metal oxide; or tungstated zirconia.

9. The method according to claim 8, wherein the method involves depolymerization of one or more selected from the group consisting of polyethylene, polypropylene, and polystyrene.

10. The method according to claim 2, wherein the depolymerization is conducted at a temperature below 300 °C.

11. The method according to claim 1, wherein the plastic material comprises polyolefin material.

12. The method according to claim 1, wherein the method involves depolymerization of a polyolefin at a temperature below 300 °C, with grinding media as said mechanical agitating part, wherein the grinding media exhibit a surface comprising a solid acid functionality.

13. A method of manufacturing grinding media having a catalytically functionalized surface, the method comprising: subjecting the grinding media to a catalytic functionalization step.

14. The method of claim 13, wherein the catalytic functionalization step introduces or enhances solid acid functionality and/or provides metal nanoparticles on the grinding media surface.

15. The method of claim 13, wherein the grinding media is provided as metal oxide milling balls, and the catalytic functionalization step involves subjecting the milling balls to sulfation with sulfuric acid.

16. Grinding media having a catalytically functionalized surface.

17. The grinding media according to claim 16, which are provided as balls for ball milling, and comprise a sulfated metal oxide surface.

18. The grinding media according to claim 16, having a surface provided with solid acid functionality and/or metal nanoparticles.

19. The grinding media according to claim 16, obtainable with a method of manufacturing grinding media having a catalytically functionalized surface, the method comprising: subjecting the grinding media to a catalytic functionalization step.

20. The method according to claim 1, with grinding media as said mechanical agitating part, wherein the grinding media are grinding media having a catalytically functionalized surface.
